(19) United States
(12) Patent Application Publication
(10) Pub. No.: US 2008/0015990 A1
(43) Pub. Date: Jan. 17, 2008

(54) METHODS FOR ELIMINATING PERSONAL IDENTIFICATION NUMBER FOR AUTHENTICATING DEBIT TRANSACTION

(76) Inventors: William S. Conley, Irving, TX (US); Thomas B. Oxendine, Denton, TX (US)

Correspondence Address: FULBRIGHT & JAWORSKI L.L.P., 600 CONGRESS AVE., SUITE 2400, AUSTIN, TX, 78701, US

(21) Appl. No.: 11/778,931

(22) Filed: Jul. 17, 2007

Related U.S. Application Data
(60) Provisional application No. 60/807,561, filed on Jul. 17, 2006.

(51) Int. Cl. G06Q 40/00

(52) U.S. Cl. 705/44

(57) ABSTRACT

Systems and methods for validating a PIN (personal identification number)-less financial transaction request are provided. Transaction data from a card and an authentication key may be submitted by a merchant to a data center. The authentication key may be generated by the merchant and may be an alpha, numeric, or alphanumeric key that may be associated with business data between the merchant and the cardholder. At the data center, the authentication key may be authenticated by comparing the authentication key with a population of valid authentication keys associated with the merchant. If the authentication key is validated, the transaction request, e.g. product sale transaction, may be evaluated and a confirmation, e.g., approval or denial, may be subsequently sent back to the merchant.

This application claims priority to, and incorporates by reference, U.S. Provisional Patent Application Ser. No. 60/807,561 entitled, “METHODS FOR ELIMINATING PERSONAL IDENTIFICATION NUMBER FOR AUTHENTICATING DEBIT TRANSACTION,” which was filed on Jul. 17, 2006.

### BACKGROUND OF THE INVENTION

1. Field of the Invention

The present invention relates generally to processing of data. More particularly, the present invention involves processing a debit transaction without the transmission of a personal identification number.

2. Description of Related Art

Generally, in most cashless point of sale (POS) transactions involving credit cards, debit cards, prepaid cards, and the like, data encoded on a magnetic strip of the card may be used to validate and process the payment transaction request. The data that may be encoded on the magnetic stripes of these cards may include the card number, card expiration date, cardholder name, credit limit, and the like. Various systems are known for conducting electronic transactions including information stored on these magnetic strips over a telecommunications link such as a telephone line, internet line, or wireless medium. One well known system is known as electronic funds transfer at point-of-sale (EFTPOS) system equipped for reading the magnetic strip on the reverse of the card.

In use, when a cardholder wishes to make a purchase for services rendered or merchandise, a debit or credit card may be tendered and swiped through a card reader system, and information relating to the identity of the cardholder, the identity of the retail store and the value of the goods or services being purchased is transmitted to a remote computer server operated by the card issuer (normally a bank or the like). Alternatively, for electronic commerce transactions, a cardholder may enter data identifying the cardholder and data related to the card. A remote computer system checks the cardholder's account and determines if sufficient funds or credit is available to cover the proposed transaction. Additionally, the remote computer system may determine if the cardholder's account is currently operational (for example, to check that the card has not been reported stolen), and then issues a confirmation signal back to the card reader to indicate that the transaction may be authorized.

In some POS transactions, a personal identification number, usually a four digit number is required from the cardholder. Instead of or in addition to providing a specimen of his or her signature at the POS, the cardholder is required to enter his or her PIN into the card reader, and this information is transmitted to the remote computer system together with the card and retail store identification data and data regarding the value of the transaction. By providing an extra identification check by way of the PIN, the current system helps to prevent fraud by forgery of signatures, but is still not completely secure because the PIN does not change between transactions, and may therefore be intercepted together with card identification data when being transmitted between the card reader and the remote server.

Any shortcoming mentioned above is not intended to be exhaustive, but rather is among many that tend to impair the effectiveness of previously known techniques for authenticating a financial transaction; however, shortcomings mentioned here are sufficient to demonstrate that the methodologies appearing in the art have not been satisfactory and that a significant need exists for the techniques described and claimed in this disclosure.

### SUMMARY OF THE INVENTION

The present disclosure provides for a financial transaction request using a debit capable card as the selected payment instrument to be processed via a debit processing network without the submittal of a Personal Identification Number (PIN) to authenticate the transaction.

In one respect, a method is provided. The method may provide, amongst other things, steps for confirming transaction data collected from a card. The method may provide obtaining the card from a cardholder and collecting the transaction data using a data input system. Additionally, the method may provide obtaining an authentication key for the cardholder from a merchant and transmitting the transaction data and authentication key to a data center. Prior to evaluating the transaction data, the authentication key is authenticated. If the authentication key is validated, the transaction data is evaluated and a confirmation of the transaction data may be forwarded to the data input system.

In one embodiment, the authentication key may be generated by the merchant. In particular, the merchant may typically generate an authentication key for each of his/her clients and may populate a population of authentication keys. The population of authentication keys may be provided to the data center at the time of transmitting the transaction data and authentication key particular to a client. Alternatively, the population of authentication keys may be submitted to the data center prior to the transmission of the transaction data and the authentication key particular to a client. The merchant may submit the population when a new authentication key is generated or at fixed time intervals, whether or not new authentication keys have been generated. In the step of authenticating the transmitted authentication key, the population of authentication keys may be used to compare with the transmitted authentication key.

The term “originator of a transaction” refers to a merchant, e.g., retailer or a person providing a service that initiates a point of sale transaction.

The term “customer” refers to a person who may business relations with a merchant. The customer may buy goods from the merchant and/or may receive services from the merchant. In some respect, a customer may be a representative from a company that has business relations with a merchant.

In some respect, a customer may be a cardholder, and more particularly, possess a credit or debit card that may be used during transaction request, e.g., product sale transaction. Alternatively, a customer may be an authorized user of the credit or debit card. The term customer and cardholder may be used interchangeably throughout the disclosure.

The term “authentication key,” as used and defined in this disclosure, is a key generated by an originator of a transaction. The authentication key is a separate set of information uniquely identifying a customer (e.g., an individual person, client, or an organization) from all other customers associated with the originator of the transaction request. The authentication key is not related to the Personal Identification Number (PIN) assigned by the issuer of the debit capable payment instrument of a cardholder. Instead, the authentication key can be based on an existing business relationship with the originator of the financial transaction request (e.g., a merchant) and may include, without limitation, a customer account number, a customer identification number, or a customer insurance policy number.

The term “debit capable card” is a card that is linked to a debit account where funds are available to withdraw from when a transaction takes place. Debit capable cards may include, without limitation, a debit card issued to a cardholder, where the debit card is linked to a checking account, savings account, money market account, or other accounts that may have readily available funds for withdrawal. Alternatively, debit capable cards may include gift cards, prepaid calling cards, merchandise cards, and the like. Each of these cards may have a finite amount of funds available for use.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The figures are examples only. They do not limit the scope of the invention.

FIG. 1 shows a method for authenticating a transaction, in accordance with embodiments of the present disclosure.

### DESCRIPTION OF ILLUSTRATIVE EMBODIMENTS

This disclosure and the various features and advantageous details of its subject matter are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those or ordinary skill in the art from this disclosure.

The present disclosure provides for authorizing a payment transaction for services, merchandise, bills, and the like using a standard credit or debit card point of sale device without transmitting a Personal Identification Number (PIN) from the point of sale device. The transaction data and authentication key may be collected using a standard point of sale device used to gather payment transaction data for non-debit or debit capable card transactions. Transaction data may include information such as: card number, expiration date (if applicable), transaction amount, tax amount, product identification. This data along with the authentication key may subsequently be sent to a data center processing host which may validate and authenticate the transaction. Once the transaction data has been validated and authenticated, the cardholder's identifying information and transaction data may be forwarded to an applicable debit processor or debit card association for evaluation and approval/disapproval.

In some respects, the results of the approval/disapproval may be returned to the data center, where the response information may be stored in a secure electronic database or file. The response information may also be forwarded to the originating point of sale device in order to inform the user/operator/consumer of the results of the payment transaction request.

Generating Authentication Keys

In some embodiments, authentication keys may be generated by an originator of the financial transaction request (e.g., service provider, retailer, merchant, business owner, etc.) as a normal course of business. The originator may assign a customer an authentication key to identify him/her/it within a population of others. In some respects, the authentication keys may be an account number, customer identification number, insurance policy number, customer identification number, or other type of identifier sufficient to securely identify a customer (e.g., sufficient to establish a unique correspondence with a customer). Alternatively, a random authentication key may be generated for each customer. The authentication keys may be maintained by the originator of the financial transaction as part of an electronic computer system, a paper-based account management system, or any combination of the two.

In some embodiments, an authentication key may be an alpha, numeric or alphanumeric, sequential or non-sequential, or algorithmically related to some aspect of the customer, supplier, agent, and/or partner's name, address, phone number, and the like. Alternatively or in addition to the above, an authentication key may relate to other data relating to different facets of the business relationship between the originator of the financial transaction request and the customer.

The population of authentication keys may be submitted to a data center or other entity in a variety of ways. For example, an electronic file containing a listing of authentication keys may be transmitted to a data center to be uploaded into an electronic data storage medium maintained at the data center. In other embodiments, the data center may query the originator of the financial transaction regarding a specific authentication key, to which the originator would respond with a value indicating the presence or absence of the authentication key within the population of authentication keys.

The authentication key is not related to the Personal Identification Number (PIN) assigned by the financial institution that issued the debit capable card to the cardholder. In some embodiments, the authentication key may not be known to the financial institution that issued the debit capable card to the cardholder. Further, changes in the authentication key will not be reflected by changes in the Personal Identification Number (PIN) or vice versa.

Point of Sale Systems

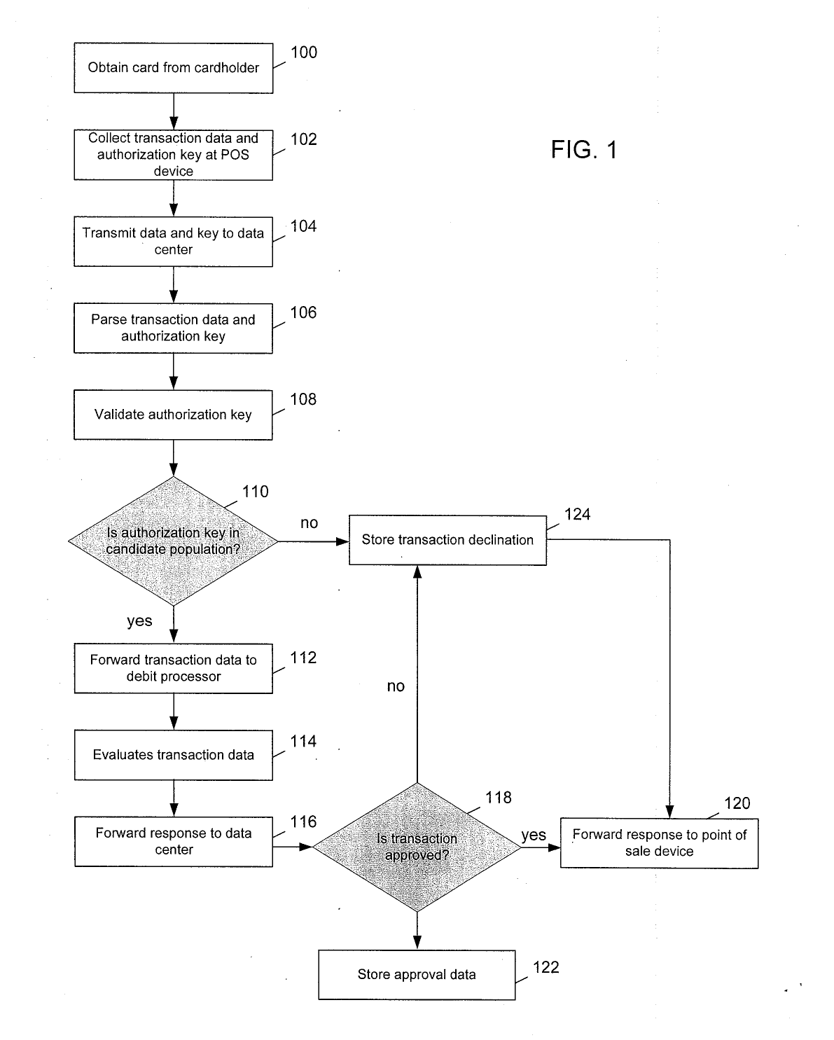

Referring to FIG. 1, upon initiating a financial transaction using a debit capable bank issued payment instrument, commonly referred to as a debit or check card (step 100), the cardholder information may be gathered from one of several different data input systems (step 102). For example, the data input system may include a point of sale device equipped with a magnetic card stripe reader. Alternatively, the data input system may include an operator-entered cardholder system that includes hardware and software applications designed for, amongst other things, processing collected payment transaction data at a point of sale (e.g., merchant). The data input system may also include an electronic cardholder system for processing from a persistent electronic storage medium. Additionally, the data input system may include an electronic cardholder system for processing pre-enrolled payment transaction from a storage medium. Examples of data input systems may include, without limitation the Hypercom T7P or the Hypercom T7Plus from Hypercom Corporation (Phoenix, Ariz.), or the Verifone Omni 3200SE or 3750 or the Verifone Tranz 330 from Verifone Inc., (Savannah, Ga.). Alternatively, the data input system may include a processor with software that may emulate a data input system. The software may allow for, amongst other things, the validation of transaction request over, for example, the Internet or when the merchant is at a remote location, i.e., when the debit capable card can not be run through a data input system.

In each of the above data input systems, a Personal Identification Number (PIN) assigned by the financial institution that issued the debit capable payment instrument to the cardholder is not required by the input process or device, nor does a PIN need to be transmitted to the data center. The cardholder information, along with the authentication key can be packaged into an agreed upon electronic format and transmitted to the data center (step 104).

In one embodiment, the transaction data and the authentication key may be submitted over a physical connection line such as a telephone line. Alternatively or in addition to, the transmission may be sent over the Internet or other computer network. In other embodiments, the transmission may be sent wirelessly using components known in the art including cellular phones, satellites or other wireless transmitters and receivers. One of ordinary skill in the art will recognize that other suitable transmission techniques may also be used.

Data Center

A data center may be used to validate various types of transactions entered into a data input system. In one respect, a product sale transaction may be sent as a request from the data input system to the data center. The product sale transaction may involve a financial and/or inventory adjustment transaction and may correspond to merchandise purchased or services rendered. In one embodiment, the product sale transaction request may be sent in XML as follows, although it is noted that other coding languages may be used:

<?xml version=“1.0” encoding=“utf-8” ?>
<TransactionRequest>

<RequestType> 1 </RequestType>

<!-- Integer-based value identifying request type 1 -->

<OperatorId></OperatorId>

<!-- Customer assigned operator id used to associate
terminal activity with a
particular operator. -->

<TransactionDateTime></TransactionDateTime>

<!-- Date and time of the transaction in YYYYMMDD
HH:MM:SS (24 hour clock)
format. -->

<AuthorizationKey> 1 </ AuthorizationKey>

<--Alpha, Numeric, or Alphanumeric authorization
key associated with the consumer
-->

<TransactionData>

<TransactionItems>

<TransactionItem>

<ProductData>

<!-- This section defines 1 to n products sold
during the transaction
request. -- >

<ProductItem>

<MeterId></MeterId>

<!-- LC meter ID -->

<DispenserId></DispenserId>

<!--Customer assigned dispenser ID for
multiple dispenser
applications -->

<ProductCode></ProductCode>

<!-Customer defined/maintained A/N
code for the product sold
during
transaction-->

<ProductDescription></ProductDescription>

<!--Human readable product description. -->

<ProductAmount></ProductAmount>

<!-- Amount of products in this transaction in units
(defined in <ProductUnits>). -->

<UnitPrice></UnitPrice>

<!-- Price per unit (defined in <ProductUnits>)
of product. -->

<ProductUnits></ProductUnits>

<!-- Units the product in this section is to be
measured in. -->

<CountryOfOrigin></CountryOfOrigin>

<!-- Country of origin of the product defined
in this section. -->

<DeliveryLocationData>

<! -- Delivery location information. -->

<Name></Name>

<!-- Consumer name (alphanumeric, optional). -->

<Address></Address>

<!-- Delivery location address (alphanumeric,
optional). -->

<City></City>

<!-- Delivery location city (alphanumeric, optional). -->

<State></State>

<!-- Delivery location state (alphanumeric, optional). -->

<PostalCode></PostalCode>

<!-- Delivery location postal code (alphanumeric,
optional). -->

<Latitude></Latitude>

<!-- Ascii latitude ‘-’ = East -->

<Longitude></Longitude>

<!-- Ascii longitude ‘-’ = South -->

<Altitude></Altitude>

<!-- Ascii Altitude in meters above sea level -->

<Odometer></Odometer>

<!-- Virtual Odometer value in meters -->

</DeliveryLocationData>
<TaxItem>

<!-- 1 to n <TaxItem> elements can be appended in
this section. -->

<TaxItemType></TaxItemType>

<!-Customer defined integer tax type, for
categorization of tax
items -->

<TaxItemDescription></TaxItemDescription>

<!-- Human readable description of <TaxItem>. -->

<TaxItemCurrencyType></TaxItemCurrencyType>

<!-- Currency type of the <TaxItem>. -->

<TaxItemAmount></TaxItemAmount>

<!-- Amount in the currency defined in
<TaxItemCurrencyType>-->

<TaxItemRate></TaxItemRate>

<!-Tax rate for this tax item, in percent -->

</TaxItem>
<ParametricDataItem>

<!-- Ex: Temperature, GrossUnits, NetUnits,
Units, Density,
SpecificGravity, etc. -->

<ParametricDataItemKey></ParametricDataItemKey>
<ParametricDataItemValue></ParametricDataItemValue>

</ParametricDataItem>

</ProductItem>

</ProductData>
<PaymentItems>

<!-- 1 to n payment items, must reflect total consideration
for the prods in
<ProductData> section. -->

<PaymentItem>

<PaymentItemId></PaymentItemId>

<!-- User assigned integer-base id for the
<PaymentItem>. Will be
used to correlate the <PaymentItem> listed in the
request with the
response. -->

<PaymentItemCurrencyType>
</PaymentItemCurrencyType>

<!-- Enumeration of all supported currency types,
omission indicates
terminal configuration default value will be used. -->

<PaymentItemType></PaymentItemType>

<!-- Integer enumeration representing payment
instrument type. Ex:
Cash=0, Check=1, ACH=2, Money Order = 3, etc. -->

<PaymentItemAmount></PaymentItemAmount>

<!--Amount to be charged to this payment item. -->

<PAN>

<PANRT></PANRT>

<!-- R&T number. Used only for check and ACH
payment types. -->

<PANAccount></PANAccount>

<!-- Personal account number: maps to the
account number for
payment type (credit card number, debit card
number, MICR line,
etc.). Used for all payments types. -->

<PANCheckNumber></PANCheckNumber>

<!-- Check number. Used only for check and ACH
payment types. -->

</PAN>
<CID>/<CID>

<!-- Encrypted Cardholder Identification
value block. -->

<ExpDate></ExpDate>

<!-- Expiration date of instrument. Used for
credit card and some
debit payment types. -->

<PaymentItemExtendedData>

<PaymentItemExtendedDataItem><!-- Ex: PO
Number, payment
terms, etc. -->

<PaymentItemExtendedDataKey></PaymentItemExtendedDataKey>
<PaymentItemExtendedDataValue></PaymentItemExtendedDataValue>

</PaymentItemExtendedDataItem>

</PaymentItemExtendedData>

</PaymentItem>

</PaymentItems>

</TransactionItem>

</TransactionItems>

</TransactionData>
</TransactionRequest>

In this embodiment, when the request arrives at a data center, the transaction data and the authentication key, <AuthorizationKey> may be parsed and evaluated to determine if the payment instrument, <PaymentItemType> is debit capable and if it is sufficient to identify the customer within the population of customers in the financial transaction originator's customer base (step 106). It is noted that the request does not include a personal identification number (PIN) associated with the payment instrument, and in particular, a debit capable card.

In one embodiment, the authentication key may be generated and maintained by the originator of the financial transaction as described above. In such an embodiment, the issuer of the debit capable payment instrument has neither prior knowledge nor any maintenance responsibility for this authentication key.

At the data center, the authentication key may be validated against a population of eligible candidate authentication keys, supplied by the originator of the transaction prior to or at the time of the transaction request (step 108). In some embodiments, the population of candidate authentication keys may be stored at an electronic database at the data center. Alternatively, the population of candidate authentication keys may be stored in an electronic file at the data center. If the authentication key is found in the population of valid candidate authentication keys and if it is sufficient to identify the customer within the population of customers in the merchant's customer base, the authentication key is deemed to positively match. Additional comparisons may be completed as a part of the authentication process, but are not necessary to complete the transaction.

In some embodiments, the population of candidate authentication keys may be stored at several locations outside of the data center. Therefore, the data center may need to include an interface with these outside locations to validate the authentication key. In some embodiments, the data center may provide a request to access the population of candidate authentication keys via a communication channel (wired or wireless). The request may be over the Internet. Alternatively, the request may be through a networked system. The request may be received at the location storing the population of candidate authentication keys and in return, the authorization of the authentication keys may be determined.

Upon completion of validation of the authentication key (either remotely or at an off-data-center location), the transaction data and other data exclusive of the PIN (e.g., volumetric product data, itemized product data, tax data, geo-location data, operator identification data, etc.) may be transmitted to an appropriate debit processor including, for example, card association, ACH processor, federal reserve, bank, or financial institution (step 112). The debit processor may evaluate the transaction data,.e.g., determine if the current transaction is capable of being funded and is approved for funding by the issuing financial institution, determine if the card is valid (not reported stolen), or the like (step 114). Based on the evaluation, the debit processor may determine if the requested transaction is approved or denied and may forward the decision to the data center (steps 116 and 118, respectively).

If the transaction is approved, the approval may be forwarded to the data input system, e.g., point of sale device (step 120), where the merchant may finalize the transaction, e.g., to advise the user/operator/consumer of the state of the transaction request. In one embodiment, the response may be written in XML as follows:

<?xml version=“1.0“ encoding=“utf-8” ?>
<TransactionResponse>

<RequestType> 1 </RequestType>

<!-- Echo from transaction request: Integer-based value
identifying the type 1
response. -->

<CustomerId></CustomerId>

<!-- Echo from transaction request: QT assigned
customer alphanumeric
identifier. -->

<TerminalId></TerminalId>

<!-- Echo from transaction request: QT assigned terminal
identifier. -->

<OperatorId></OperatorId>

<!-- Echo from transaction request: Customer assigned operator
id to be used
to associate terminal activity with a particular operator. -->

<TransactionDateTime></TransactionDateTime>

<!-- Echo from transaction request: The date and time of
the transaction in
YYYYMMDD HH:MM:SS (24 hour clock) format. -->

<TransactionId></TransactionId>

<!-- Alpha based unique identifier for the transaction.
Assigned by the QT
host. -->

<TransactionResults>

<ResponseCode></ResponseCode>

<!-- Integer-based response code identifying the results
of the transaction
request. -->

<ResponseMessage></ResponseMessage>

<!-- Human readable alphanumeric response message
describing the
<ResponseCode> received by the terminal. -->

</TransactionResults>
<PaymentItemResponses>

<!-- 1 to n payment items that must reflect the total
consideration for the sale
of the products defined in the <ProductData> section. -->

<PaymentItemResponse>

<PaymentItemId></PaymentItemId>

<!-- User assigned integer-base id for the
<PaymentItem>. Will be used to
correlate the <PaymentItem> listed in the request with
the response. -->

<PaymentItemReponseCode></PaymentItemReponseCode>

<!-- Integer-based response for the <PaymentItem>. -->

<PaymentItemReponseMsg></PaymentItemReponseMsg>

<!-- Alphanumeric human readable description of the
<PaymentItemResponseCode>. -->

<PaymentItemResponseData>

<!-- Any of the following may be present depending on the
<PaymentItemType>. -->
<!-- Credit card response data. -->

<ApprovalCode></ApprovalCode>

<!-- Alphanumeric value indicating the approval response
code returned by
the FI. -->

<AVSResponseCode></AVSResponseCode>

<!-- Address verification service response code (used
for card not present
transactions only). -->

<AVSResponseMsg></AVSResponseMsg>

<!-- Address verification service human readable description
(used for card
not present transactions only). -->

<CIDResponseCode></CIDResponseCode>

<!-- Cardholder identification verification response code
(used for card not
present transactions only). -->

<CIDResponseMsg></CIDResponseMsg>

<!-- Cardholder identification verification human readable
description (used
for card not present transactions only). -->

<!-- Debit card response data. -->

<ApprovalCode></ApprovalCode>

<!-- Alphanumeric value indicating the approval response
code returned by
the FI. -->
<!-- Check / ACH response data. -->

<ApprovalCode></ApprovalCode>

<!-- Alphanumeric value indicating the approval response
code returned by
the FI.-->
<!-- Private account response data. -->

<ApprovalCode></ApprovalCode>

<!-- Alphanumeric value indicating the approval response
code returned by
the host. -->

</PaymentItemResponseData->

</PaymentItemResponse>

</PaymentItemResponses>

</TransactionResponse>

The approval may also be stored in a databank at the data center (step 122). Storage may be achieved internally and/or externally, at the data center or a remote location accessible by the data center and may include, for example, a hard drive, CD drive, DVD drive, tape drive, floppy drive, network drive, flash, or the like.

Similarly, if the transaction was denied, the transaction may be transmitted to the originator of the transaction and may be stored in the data center databank (step 124) and the denial may subsequently be forwarded to the point of sale device (step 120).

Techniques of this disclosure may be accomplished using any of a number of programming languages. Suitable languages include, but are not limited to, BASIC, FORTRAN, PASCAL, C, C++, C#, JAVA, HTML, XML, PERL, etc. An application configured to carry out the invention may be a stand-alone application, network based, or Internet based to allow easy, remote access. The application may be run on a personal computer, a data input system, a point of sale device, a PDA, cell phone or any computing mechanism.

All of the methods disclosed and claimed can be made and executed without undue experimentation in light of the present disclosure. While the methods of this invention have been described in terms of embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the disclosure as defined by the appended claims.

1. A method comprising:
obtaining a card from a customer;
collecting transaction data from the card using a data input system;
obtaining an authentication key for the customer from a merchant, the authentication key being generated by the merchant and uniquely identifying the customer;
transmitting the transaction data and the authentication key to a data center;
authenticating the authentication key by comparing the authentication key to a population of approved authentication keys;
evaluating the transaction data if the authentication key is authenticated; and
forwarding a confirmation of the transaction data to the data input system.

2. The method of claim 1, where collecting the transaction data comprises collecting data associated with the card.

3. The method of claim 1, where collecting transaction data comprises collecting a card number, a card expiration date, a transaction amount, a tax amount, or product information.

4. The method of claim 1, further comprising generating a population of authentication keys related to the merchant, each authentication key of the population being related to the merchant.

5. The method of claim 1, where evaluating the transaction data further comprises forwarding the transaction data to a debit processor.

6. The method of claim 5, where forwarding the confirmation comprises forwarding a confirmation from the debit processor to the data center.

7. A method comprising:
generating an authentication key for each of multiple clients of a merchant; and
populating a population comprising a plurality of authentication keys.

8. The method of claim 7, further comprising forwarding the population to a data center.

9. The method of claim 8, further comprising comparing an incoming authentication key transmitted with the population from a point of sale device upon initiating a financial transaction.

10. The method of claim 9, further comprising forwarding transaction data associated with the financial transaction to a debit processor if the authentication key matches one of the population.

11. The method of claim 7, where generating an authentication key comprises generating an alpha, numeric, or alphanumeric key relating to data corresponding to a client.

12. The method of claim 11, the data corresponding to the client comprising an account number, a policy number, a name, an address, or a phone number.

13. A method comprising:
generating an authentication key for a customer;
transmitting a transaction request and the authentication key using a data input system to a data center, the transaction request comprising a product sale transaction request;
authorizing the authentication key;
evaluating the transaction request if the authentication key is valid; and
forwarding a confirmation of the transaction request to the data input system.

14. The method of claim 13, where generating the authentication key comprises generating an alpha, numeric, or alphanumeric key relating to data corresponding to a customer.

15. The method of claim 13, where transmitting further comprises transmitting transaction data.

16. The method of claim 15, where transmitting the transaction data comprises transmitting data relating to a debit capable card of the customer.

17. The method of claim 15, where transmitting the transaction data comprises transmitting a debit capable card number, a debit capable card expiration date, a transaction amount, a tax amount, or product information.

18. The method of claim 13, where generating an authorization key comprises generating a population of authentication keys, each authentication key of the population being related to the merchant.

19. The method of claim 18, where authenticating the authentication key comprises comparing the authentication key with the population of authentication keys.
